(19) United States
(12) Patent Application Publication
(10) Pub. No.: US 2019/0139662 A1
(43) Pub. Date: May 9, 2019

(54) LONG-LIVED FISSION PRODUCT PROCESSING METHOD USING NEUTRONS

(71) Applicant: KYOTO UNIVERSITY, Kyoto-shi Kyoto (JP)

(72) Inventor: Yoshiharu MORI, Kyoto-shi, Kyoto (JP)

(73) Assignee: KYOTO UNIVERSITY, Kyoto-shi Kyoto (JP)

(21) Appl. No.: 16/096,434

(22) PCT Filed: Feb. 20, 2017
(86) PCT No.: PCT/JP2017/006155

§ 371 Date: Oct. 25, 2018

(30) Foreign Application Priority Data
Apr. 28, 2016 (JP) 2016-091774

(51) Int. Cl. G21F 9/00; H05H 6/00; H05H 3/06; G21K 5/04

(52) U.S. Cl. CPC G21F 9/001; H05H 6/00; G21F 9/007; G21K 5/04; H05H 3/06

(57) ABSTRACT

Provided is a long-lived fission product (LLFP) processing method using neutrons that enables generation of high-intensity neutrons using only an accelerator without a fast-neutron reactor or an accelerator-driven nuclear reactor and thereby enables efficient nuclear transmutation of long-lived fission products. In the processing method, neutron-containing primary particles such as deuterons are accelerated under specific conditions inside an FFAG accelerator (10) and are caused to collide with a plate-shaped target (18) to generate high-energy first neutrons that form a beam in a single direction through the break-up of the primary particles and low-energy diffuse second neutrons through excitation of atomic nuclei in the plate-shaped target. A first LLFP (20) is located in the direction of travel of the beam of the first neutrons and a second LLFP (24) is located in proximity to the plate-shaped target (18).

### TECHNICAL FIELD

The present disclosure relates to a method of processing long-lived fission products with neutrons generated using an accelerator.

### BACKGROUND

The processing of long-lived fission products (LLFPs) discharged in accompaniment to operation of nuclear reactors is the greatest problem facing the utilization of atomic energy. At present, burial of LLFPs by deep geological disposal is anticipated, though there is significant opposition to such disposal. There are also known techniques for rendering LLFPs radioactively harmless by nuclear transmutation using neutrons generated through nuclear fission by a fast-neutron reactor or an accelerator-driven nuclear reactor.

In principle, it is possible to render an LLFP radioactively harmless and also enable reuse as a resource by performing nuclear transmutation of the LLFP using secondary particles such as neutrons or negative muons that are generated by causing primary particles such as protons that have been accelerated to high energy by an accelerator to collide with a fixed nuclear target. In order to implement this nuclear transmutation, it is vital to generate neutrons with high efficiency at a higher intensity than conventionally achieved and to localize the generated neutrons. However, a neutron generating system including an accelerator that can generate high-intensity neutrons in a localized manner has not previously been disclosed and thus a technique for processing LLFPs using only an accelerator without a fast-neutron reactor or an accelerator-driven nuclear reactor does not exist.

For example, in one method, a beam of accelerated primary particles is taken from a linear accelerator and directed against a fixed nuclear target to generate neutrons. However, this method requires a large target having a length of 1 m or more in the incident direction of the beam and does not enable localization of a neutron generation section. Consequently, it is difficult to efficiently process LLFPs by nuclear transmutation using this method.

PTL 1 describes a technique for generating neutrons through a nuclear reaction by accelerating primary particles (protons or deuterons) while circulating these primary particles inside a ring-shaped fixed field alternating gradient (FFAG) accelerator through magnetic field and electric field effects, and causing the accelerated primary particles to collide with a plate-shaped target located inside the FFAG accelerator.

### CITATION LIST

### Patent Literature

PTL 1: JP 2006-155906 A

### SUMMARY

### Technical Problem

However, the technique described in PTL 1 cannot generate high-intensity neutrons because the accelerated primary particles have a low energy of 2.5 MeV to 10 MeV. Moreover, the generated neutrons spread out in a wide emission angle around the plate-shaped target. In other words, it has not been possible to generate high-intensity neutrons in a localized manner with the technique described in PTL 1. Note that in FIG. 1 of PTL 1, neutrons that proceed in a certain direction among the neutrons that spread out around the plate-shaped target are indicated by a dashed arrow, and PTL 1 explains that these neutrons are passed through a heavy water tank to obtain thermal neutrons or epithermal neutrons.

In view of the problems set forth above, an objective of the present disclosure is to provide a long-lived fission product processing method using neutrons that enables generation of high-intensity neutrons using only an accelerator without a fast-neutron reactor or an accelerator-driven nuclear reactor and thereby enables efficient nuclear transmutation of long-lived fission products.

### Solution to Problem

As a result of diligent investigation to solve the problems set forth above, the inventor reached the following findings. Specifically, the inventor discovered that by setting the magnetic field gradient coefficient k in an FFAG accelerator as a specific value, primary particles can be accelerated to a high energy of 50 MeV/nucleon or more (i.e., 100 MeV or more in a case in which the primary particles are deuterons), which is at least 10 times higher than conventionally achieved. Moreover, the inventor discovered that by using neutron-containing primary particles such as deuterons as the primary particles accelerated inside the FFAG accelerator and by causing these primary particles to collide with a plate-shaped target with the high energy described above, two types of nuclear reactions occurred in the form of a dissociation reaction (break up) of the primary particles themselves into neutrons and protons and a reaction in which atomic nuclei in the plate-shaped target are excited to generate neutrons.

The neutrons generated through the former of these reactions had roughly equivalent speed to the primary particles. Consequently, a neutron beam was generated that was roughly monoenergetic (monochromatic) with a high energy of roughly ½ of that of the primary particles in a case in which the primary particles were deuterons. Moreover, the emission direction of this neutron beam was focused roughly forward (i.e., in an extension direction of an incident path of the primary particles to the target). On the other hand, since the neutrons generated in the latter of the aforementioned reactions were generated from atomic nuclei in the target, these neutrons were distributed to low energies and the emission angle distribution thereof was spread out widely around the target. In this manner, neutrons totaling 1×10¹⁸ n/sec to 1×10¹⁹ n/sec, which is sufficiently high intensity for efficient nuclear transmutation of LLFPs, could be split into a high-energy component and a low-energy component, and these components could each be generated in a localized manner. Note that the intensity ratio of these two types of neutrons was roughly 1:1.

In view of these findings, the inventor conceived an idea of positioning a first LLFP in the direction of travel of the high-energy neutron beam (i.e., in a forward direction at a location separated from the ring) so as to perform nuclear transmutation of the first LLFP with the high-energy neutron beam and positioning a second LLFP in proximity to the plate-shaped target so as to perform nuclear transmutation of the second LLFP with the low-energy neutrons. As a result, it was possible to perform efficient nuclear transmutation of LLFPs.

Moreover, since a high-energy neutron beam with high directivity could be generated in this manner, it was possible to realize other technological applications besides direct use in nuclear transmutation of an LLFP. Specifically, by positioning a second target in the direction of travel of the neutron beam, negative pi-mesons can be generated through collisions of the high-energy neutrons with the second target. These negative pi-mesons decay to form negative muons that are extremely effective for performing nuclear transmutation of an LLFP.

In addition to or instead of the above, a nuclear fusion reaction can be caused by introducing the negative muons into deuterium-tritium molecules (DT molecules). This results in generation of neutrons in a large quantity of 125 to 150 neutrons per 1 negative muon. LLFP nuclear transmutation can also be performed extremely effectively using this large quantity of neutrons.

It should be noted that when protons are used as accelerated primary particles in the technique of PTL 1, a break up reaction of these primary particles clearly does not occur. Moreover, even when deuterons are used as the accelerated primary particles, a break up reaction of the primary particles does not occur because these primary particles have a low accelerated energy of 2.5 MeV to 10 MeV. Accordingly, the technique of PTL 1 provides neutrons with an intensity of 1×10¹² n/sec to 1×10¹³ n/sec at most and cannot generate a high-energy neutron beam having high directivity.

The present disclosure was completed based on the findings set forth above and the primary features thereof are as follows.

(1) A long-lived fission product processing method using neutrons comprising:

introducing neutron-containing primary particles into an FFAG accelerator including a plurality of sector magnets and at least one radio frequency accelerating device arranged in a ring shape;

accelerating the primary particles to high energy while circulating the primary particles inside the FFAG accelerator through magnetic field and electric field effects under conditions in which, in the FFAG accelerator, the frequency of a radio frequency electric field is fixed while setting a magnetic field gradient coefficient k in accordance with equation (1), shown below,

$$k \approx \frac{T}{M} ( \frac{T}{M} + 2 ) \qquad ( 1 )$$

where T is kinetic energy of the primary particles at a stage at which the primary particles form a stored beam and M is rest mass energy of the primary particles;

letting the primary particles that have been accelerated collide with a plate-shaped target located inside the FFAG accelerator to generate first neutrons of high energy through break-up of the primary particles and second neutrons of low energy through excitation of atomic nuclei in the plate-shaped target; and

performing nuclear transmutation of a first long-lived fission product through collisions of the first neutrons with the first long-lived fission product, the first neutrons forming a beam in an extension direction of an incident path of the primary particles to the plate-shaped target, and the plate-shaped target being located in a direction of travel of the beam, and

performing nuclear transmutation of a second long-lived fission product located in proximity to the plate-shaped target through the second neutrons spreading out around the plate-shaped target.

(2) The long-lived fission product processing method according to the foregoing (1), wherein the primary particles are deuterium nuclei or tritium nuclei.

(3) The long-lived fission product processing method according to the foregoing (1) or (2), wherein

the primary particles have an energy per nucleon of 50 MeV/nucleon or more when colliding with the plate-shaped target, and the plate-shaped target has a thickness of 1 mm or more.

(4) The long-lived fission product processing method according to any one of the foregoing (1) to (3), wherein

a second target, instead of the first long-lived fission product, is located in the direction of travel of the beam of the first neutrons,

the beam of the first neutrons collides with the second target to generate negative pi-mesons,

the first long-lived fission product is located in proximity to the second target, and

nuclear transmutation of the first long-lived fission product is performed through negative muons resulting from decay of the negative pi-mesons.

(5) The long-lived fission product processing method according to any one of the foregoing (1) to (3), wherein

a second target positioned in a first space, instead of the first long-lived fission product, is located in the direction of travel of the beam of the first neutrons,

the beam of the first neutrons collides with the second target to generate negative pi-mesons,

a second space filled with a gas of deuterium-tritium molecules is formed adjacently to the first space in which the second target is positioned, and a confining magnetic field is formed around the second space,

the negative pi-mesons move from the first space to the second space through an effect of the confining magnetic field,

negative muons resulting from decay of the negative pi-mesons cause a nuclear fusion reaction in the second space to generate third neutrons,

the first long-lived fission product is located in proximity to the second target, and

nuclear transmutation of the first long-lived fission product is performed through the third neutrons.

### Advantageous Effect

Through a long-lived fission product processing method using neutrons according to the present disclosure, it is possible to generate high-intensity neutrons using only an accelerator without a fast-neutron reactor or an accelerator-driven nuclear reactor and to thereby perform efficient nuclear transmutation of long-lived fission products.

### BRIEF DESCRIPTION OF THE DRAWINGS

In the accompanying drawings:

FIG. 1 schematically illustrates configuration of a neutron generating system for implementing a long-lived fission product processing method according to one embodiment of the present disclosure in an upper part thereof and schematically illustrates a mode of nuclear reaction in a plate-shaped target 18 in a lower part thereof;

FIG. 2 schematically illustrates configuration of a neutron generating system for implementing a long-lived fission product processing method according to another embodiment of the present disclosure; and

FIG. 3 schematically illustrates configuration of a neutron generating system for implementing a long-lived fission product processing method according to yet another embodiment of the present disclosure.

### DETAILED DESCRIPTION

### First Embodiment

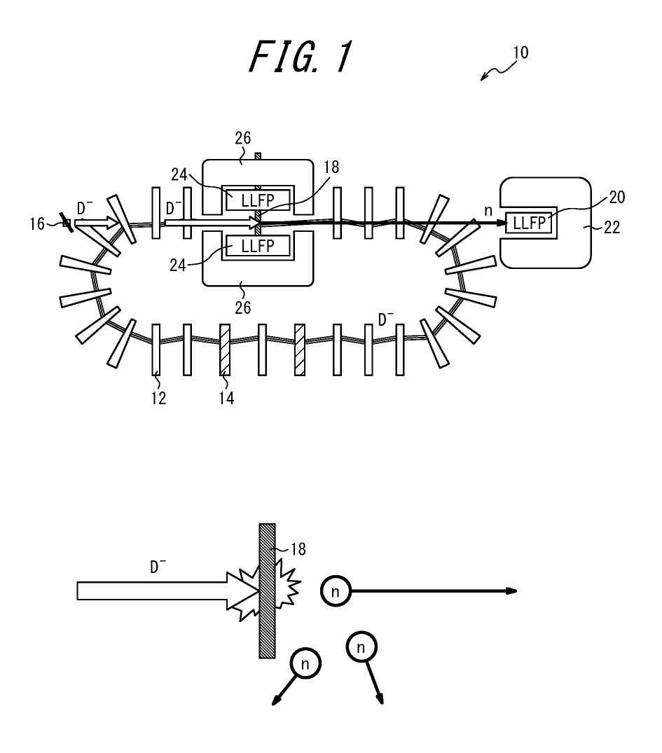

The following describes a long-lived fission product (LLFP) processing method according to one embodiment of the present disclosure. A neutron generating system illustrated in FIG. 1 includes an FFAG accelerator 10, a primary beam source 16, and a plate-shaped target 18. The FFAG accelerator 10 includes a plurality of sector magnets 12 and at least one radio frequency accelerating device 14 (two in FIG. 1) arranged in a ring shape.

Neutron-containing primary particles are introduced into the FFAG accelerator 10 from the primary beam source 16. The primary particles are not specifically limited so long as they are neutron-containing particles and are preferably deuterium nuclei (i.e., deuterons) or tritium nuclei. This is because these particles readily undergo a break-up reaction such as previously described through collision with the plate-shaped target 18. The energy per nucleon of the primary particles at the time of introduction is preferably ¼ to ½ of the subsequently described energy per nucleon of the primary particles when colliding with the plate-shaped target 18. Power required by the radio frequency accelerating devices 14 is not excessive when the energy per nucleon at introduction is at least ¼ of that at collision, whereas the load (cost and used power) of the primary beam source 16 is not excessive when the energy per nucleon at introduction is not more than ½ of that at collision.

The beam current of the primary particles is preferably 100 mA or more from a viewpoint of ensuring sufficient neutron intensity.

The introduced primary particles are accelerated to high energy while being circulated inside the FFAG accelerator 10 through magnetic field and electric field effects. Acceleration of the primary particles in this case refers to a change in the circulation time for each circuit through a change in beam speed and orbit length. For this reason, it is generally thought that acceleration cannot be implemented if the frequency of radio frequency electromagnetic waves from the radio frequency accelerating devices 14 is fixed. However, in the present embodiment, the magnetic field gradient coefficient k (k=(R/B)×(dB/dR); R: beam orbit radius; B: magnetic field strength on orbit) in the FFAG accelerator 10 is set in accordance with the following formula (1).

$$k \approx \frac{T}{M} ( \frac{T}{M} + 2 ) \qquad ( 1 )$$

In formula (1), T is the kinetic energy of the primary particles at a stage at which the primary particles form a stored beam and M is the rest mass energy of the primary particles.

Under these conditions, the beam energy relative to the circulation time undulates gradually and thus this type of acceleration of the primary particles is also referred to as serpentine acceleration. In the present embodiment, this enables acceleration of the primary particles to high energy even when the frequency of the radio frequency electric field from the radio frequency accelerating devices 14 has a fixed value. Moreover, the primary particles can be accelerated to high energy to a degree that has not been achievable with the technique of PTL 1. For example, when the energy per nucleon of the primary particles at the time of introduction is as described above, the energy per nucleon of the primary particles when colliding with the plate-shaped target 18 can be set as 50 MeV/nucleon or more, and can even be set as high as approximately 1,000 MeV/nucleon. In other words, in a case in which the primary particles are deuterons, the total kinetic energy of the primary particles can be set as 100 MeV or more, and can even be set as high as approximately 2,000 MeV. When the energy per nucleon of the primary particles when colliding with the plate-shaped target 18 is 50 MeV/nucleon or more, high-energy first neutrons can be efficiently generated through break-up of the primary particles, and when the energy per nucleon of the primary particles when colliding is 1,000 MeV/nucleon or less, the energy of negative muons generated separately to the neutrons does not become excessively high. Note that the frequency of the electric field is generally on the scale of megahertz to tens of megahertz, but is not specifically limited and may be set as an even higher frequency.

In this manner, the primary particles are accelerated to high energy while being circulated inside the FFAG accelerator 10 through magnetic field and electric field effects under conditions in which the frequency of the radio frequency electric field is fixed while setting the magnetic field gradient coefficient k as described above. The accelerated primary particles collide with the plate-shaped target 18 located inside the FFAG accelerator 10.

The plate-shaped target 18 may be a typical nuclear target. For example, the plate-shaped target 18 may be made from a material selected from beryllium, lithium, and compounds thereof. The shape of a principal surface of the plate-shaped target 18 is not specifically limited and may, for example, be a wedge shape. The thickness of the plate-shaped target 18 is preferably selected in accordance with the energy per nucleon of the primary particles at the time of collision. For example, the thickness is preferably approximately 1 mm to 2 mm when the energy per nucleon is 50 MeV/nucleon, approximately 2 mm to 5 mm when the energy per nucleon is 100 MeV/nucleon, and approximately 10 mm to 50 mm when the energy per nucleon is 1,000 MeV/nucleon, which is anticipated as the aforementioned upper limit.

When a beam of primary particles that have been accelerated to high energy as described above collides with the plate-shaped target 18, high-energy first neutrons are generated through the break-up of the primary particles and low-energy second neutrons are generated through excitation of atomic nuclei in the plate-shaped target 18.

The first neutrons are high-energy neutrons and thus form a beam having high directivity in an extension direction of an incident path of the primary particles to the plate-shaped target 18. Moreover, the generated first neutrons hardly collide with atomic nuclei in the target because of the target having a thin plate shape and consequently form a monoenergetic (monochromatic) neutron beam. For example, in a case in which the primary particles are deuterons and the energy thereof at the time of collision is 200 MeV, a high-energy neutron beam of approximately ½ of this energy (i.e., 100 MeV) is formed. In other words, when these energies are expressed as energies per nucleon, a neutron beam of equivalent energy to the energy of the primary particles at the time of collision with the plate-shaped target 18 is formed.

On the other hand, the second neutrons are distributed to low energies and spread out around the plate-shaped target 18 as a result of being generated from atomic nuclei in the plate-shaped target 18. For example, in a case in which the primary particles are deuterons and the energy thereof at the time of collision is 200 MeV, the energy of the second neutrons is, on average, approximately a few MeV to 30 MeV.

Also note that primary particles that lose energy and slow through collision with the plate-shaped target 18 are reaccelerated to the high energy described above inside the FFAG accelerator 10. Moreover, by setting a target thickness that is in accordance with the energy of the primary particles as described above, electromagnetic energy loss in the target and energy increase through beam acceleration are in equilibrium. Consequently, a beam of the primary particles can be stored at a fixed energy and neutrons can be continuously generated through a process in which the primary particle beam repeatedly collides with the target many times (approximately 100 times). More specifically, the probability of a single primary particle undergoing a break-up reaction through a single collision is low but the probability of the single primary particle undergoing a break-up reaction is increased through repeated collision thereof. Explained another way, primary particles that undergo a break-up reaction in a single collision only constitute a very small portion of all colliding primary particles, whereas the majority of the colliding primary particles lose energy through collision but continue to circulate without breaking up. However, the first neutrons can be generated with optimal efficiency by once again accelerating these primary particles and causing them to collide with the target again. Moreover, low-energy second neutrons are generated in each collision as the primary particles repeatedly collide with the target. The first neutrons and second neutrons can be continuously generated by the mechanism described above by continuously supplying primary particles from the primary beam source 16.

In the present embodiment, neutrons totaling 1×10¹⁸ n/sec to 1×10¹⁹ n/sec, which is sufficiently high intensity for efficient nuclear transmutation of LLFPs, can be split into a high-energy component and a low-energy component, and these components can each be generated in a localized manner. As illustrated in FIG. 1, a first LLFP 20 is located in the direction of travel of the beam formed by the first neutrons and a second LLFP 24 is located in proximity to the plate-shaped target 18. Consequently, the beam formed by the first neutrons collides with the first LLFP 20 such as to perform nuclear transmutation of the first LLFP 20 and the second neutrons perform nuclear transmutation of the second LLFP 24. An LLFP processing system such as described above can perform efficient nuclear transmutation of LLFPs so as to convert the LLFPs to stable substances without radioactivity.

A shielding plate 22 is provided around the first LLFP 20 and a shielding plate 26 is provided around the second LLFP 24. These shielding plates 22 and 26 may be made from a commonly known material or any other material so long as they can shield against radiation such as y-rays generated in association with nuclear transmutation. The localized generation of neutrons in the present embodiment has benefits of enabling compact arrangement of the LLFPs and compact radiation shielding.

### Second Embodiment

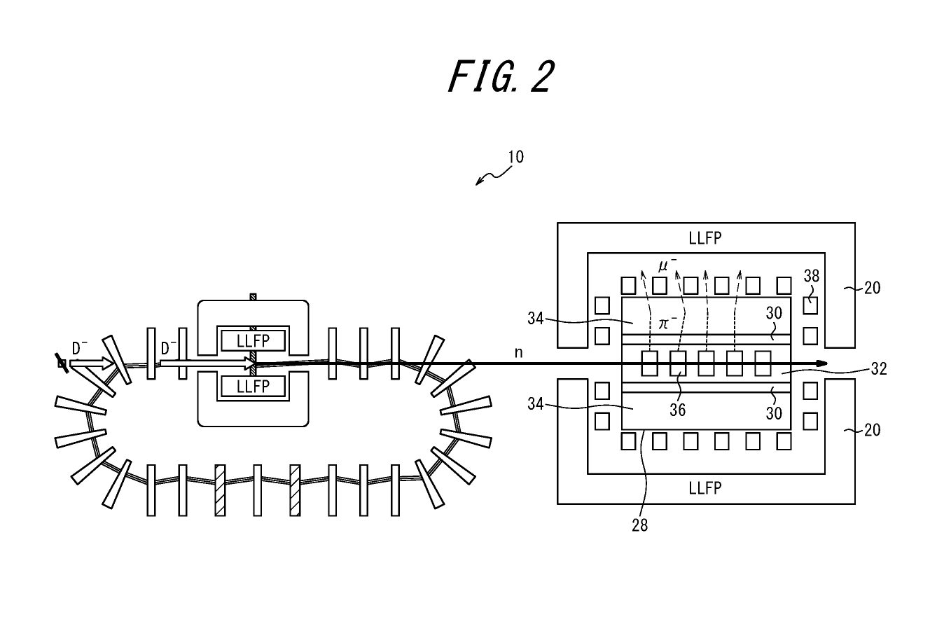

The following describes a long-lived fission product (LLFP) processing method according to another embodiment of the present disclosure with reference to FIG. 2.

The configuration by which high-energy first neutrons and low-energy second neutrons are generated by the FFAG accelerator 10 is the same as in the first embodiment illustrated in FIG. 1. Therefore, description of this configuration is omitted. In the present embodiment, a second target 36 positioned in a first space 32 that is a vacuum or atmospheric space, instead of the first LLFP 20, is located in the direction of travel of the beam of the first neutrons and the beam of the first neutrons collides with the second target 36 as illustrated in FIG. 2.

The following describes configuration in proximity to the second target 36. The inside of a housing 28 is divided into the first space 32 and a second space 34 by a partition 30. The first space 32 is a vacuum or atmospheric space and the second target 36 is located therein. A substance (for example, graphite; not illustrated) for slowing generated negative muons (described below) is installed in the second space 34. A solenoid coil 38 for generating a confining magnetic field is located around the housing 28. A first LLFP 20 is located in proximity to the second target. More specifically, the first LLFP 20 is located outside of the housing 28 and the confining magnetic field and, in the present embodiment, is located around the housing 28.

The materials of the housing 28 and the partition 30 are not specifically limited so long as they can divide the first space 32 and the second space 34 as described above. For example, the housing 28 and the partition 30 may be made from an iron plate or a steel plate having a thickness on the order of several millimeters. The second target 36 may be a typical nuclear target. For example, the second target 36 may be made from a material selected from beryllium, lithium, and compounds thereof. Moreover, no limitations are placed on the solenoid coil 38 so long as it can generate a confining magnetic field and may be toroidal, helical, or the like. The solenoid coil 38 has a function of increasing residence time in the second space 34 of generated negative pi-mesons (described below) so as to enable efficient conversion of the negative pi-mesons to negative muons.

Negative pi-mesons (π⁻) are generated through collision of the neutron beam with the second target 36 in a situation in which the energy of the neutron beam is 300 MeV or more. Herein, it is preferable that the thickness of the second target 36 in the direction of travel of the neutron beam is set within a range of 10 mm to 100 mm and that a plurality (preferably 10 to 100) of such second targets 36 are provided with a total thickness of approximately 1 m. Separate targets are provided because if a single target of 1 m in thickness is used, the generated negative pi-mesons are converted to pi-mesons (π⁰) inside the target.

In the present embodiment, 0.2 negative pi-mesons are generated per 1 neutron and these negative pi-mesons decay with a lifetime of 2.6×10⁻⁸ sec to form negative muons (μ⁻). For example, in a case in which the total intensity of the first and second neutrons in the first embodiment is 1×10¹⁸ n/sec to 1×10¹⁹ n/sec as mentioned above, the intensity of the first neutrons is half thereof (i.e., 5×10¹⁷ n/sec to 5×10¹⁸ n/sec) and, in this situation, negative muons can be obtained with an intensity of 1×10¹⁷μ⁻/sec to 1×10¹⁸μ⁻/sec. Nuclear transmutation of the first LLFP 20 can be performed by this large quantity of negative muons. Note that although the intensity of negative muons colliding with the first LLFP 20 in the present embodiment is ⅕ of the intensity of the first neutrons colliding with the first LLFP 20 in the first embodiment, nuclear transmutation of the LLFP can be performed with higher efficiency in the present embodiment than in the first embodiment (20 times higher) because negative muons have a nuclear transmutation efficiency of close to 100 times higher than neutrons. In other words, equivalent processing efficiency of the first LLFP 20 to in the first embodiment can be achieved in the present embodiment even when the intensity of the first neutrons is approximately 1/20 of the intensity in the first embodiment.

### Third Embodiment

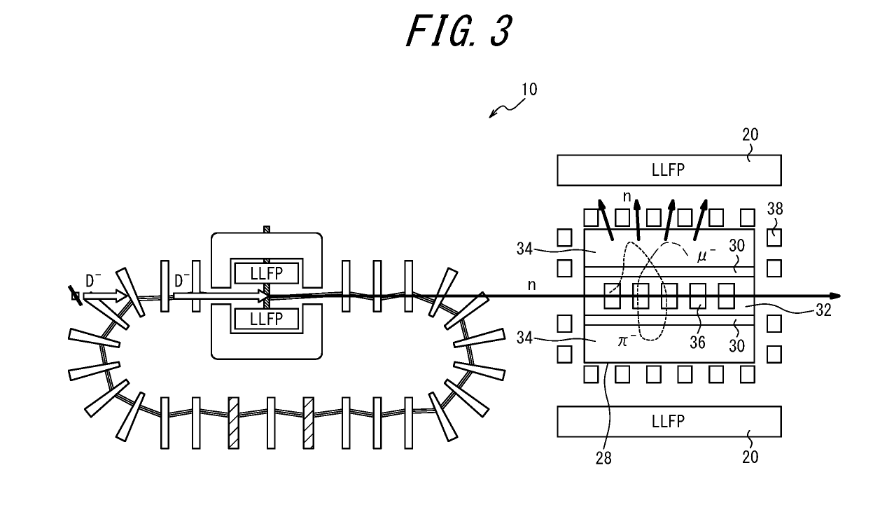

The following describes a long-lived fission product (LLFP) processing method according to yet another embodiment of the present disclosure with reference to FIG. 3.

The configuration by which high-energy first neutrons and low-energy second neutrons are generated by the FFAG accelerator 10 is the same as in the first embodiment illustrated in FIG. 1. Therefore, description of this configuration is omitted. In the present embodiment, a second target 36 positioned in a first space 32 that is a vacuum or atmospheric space, instead of the first LLFP 20, is located in the direction of travel of the beam of the first neutrons and the beam of the first neutrons collides with the second target 36 in the same manner as in FIG. 2. The configuration in proximity to the second target 36 is the same as illustrated in FIG. 2 with the exception that the second space 34 is filled with 10 atm to 100 atm of a gas of deuterium-tritium molecules (DT molecules) in the present embodiment.

Negative pi-mesons (π⁻) are generated through collision of the neutron beam with the second target 36 in a situation in which the energy of the neutron beam is 300 MeV or more. The negative pi-mesons move from the first space 32 to the second space 34 through an effect of the confining magnetic field and decay to form negative muons (μ⁻) in this process. The negative muons cause a nuclear fusion reaction upon entering the deuterium-tritium molecules (DT molecules). As a result, neutrons (third neutrons) are generated in a large quantity of 125 to 150 neutrons per 1 negative muon through nuclear fusion reaction in the DT molecule-filled second space 34. The intensity of the third neutrons is 25 times to 30 times the intensity of the first neutrons. Nuclear transmutation of the first LLFP 20 can be performed by this large quantity of third neutrons. Note that the energy of the third neutrons is approximately 14 MeV.

μ⁻+DT→n+He+μ⁺ Reaction formula:

Moreover, in the present embodiment, negative muons that do not cause a nuclear fusion reaction in the second space 34 can perform nuclear transmutation of the first LLFP 20.

(Electricity Generation by Negative Muon-Catalyzed Nuclear Fusion)

The third embodiment illustrated in FIG. 3 is also useful as an electricity generation technique. In negative muon-catalyzed nuclear fusion, approximately 3 GeV of energy is generated with one negative muon. This corresponds to approximately 15 times the nuclear fission energy of ²³⁵U. Therefore, an electricity generating method and an electricity generating system that convert this energy to electrical power are also constituents of the present disclosure. This electrical power can, for example, be used to meet the electrical power requirements of the LLFP processing system in the present embodiment.

No specific limitations are placed on the electricity generating mechanism by which energy generated through the negative muon-catalyzed nuclear fusion is converted to electrical power and a commonly known electricity generating mechanism or any other electricity generating mechanism may be used. For example, electricity can be generated by positioning a lithium blanket (not illustrated) in proximity to the second target 36 in the same manner as the first LLFP 20 in FIG. 3, converting energy of the third neutrons to thermal energy inside the blanket, producing steam through a heat exchanger (steam generator), and turning an electricity generating turbine to rotate an electricity generator.

### INDUSTRIAL APPLICABILITY

Through a long-lived fission product processing method using neutrons according to the present disclosure, it is possible to generate high intensity neutrons using only an accelerator without a fast-neutron reactor or an accelerator-driven nuclear reactor and to perform efficient nuclear transmutation of long-lived fission products.

### REFERENCE SIGNS LIST

10 FFAG accelerator
12 sector magnet
14 radio frequency accelerating device
16 primary beam source
18 plate-shaped target
20 first LLFP
22 shielding plate
24 second LLFP
26 shielding plate
28 housing
30 partition
32 first space (vacuum or atmospheric)
34 second space (DT molecule-filled)
36 second target
38 solenoid coil

1. A long-lived fission product processing method using neutrons comprising:
introducing neutron-containing primary particles into an FFAG accelerator including a plurality of sector magnets and at least one radio frequency accelerating device arranged in a ring shape;
accelerating the primary particles to high energy while circulating the primary particles inside the FFAG accelerator through magnetic field and electric field effects under conditions in which, in the FFAG accelerator, the frequency of a radio frequency electric field is fixed while setting a magnetic field gradient coefficient k in accordance with equation (1), shown below,
$$k \approx \frac{T}{M} ( \frac{T}{M} + 2 ) \qquad ( 1 )$$
where T is kinetic energy of the primary particles at a stage at which the primary particles form a stored beam and M is rest mass energy of the primary particles;
letting the primary particles that have been accelerated collide with a plate-shaped target located inside the FFAG accelerator to generate first neutrons of high energy through break-up of the primary particles and second neutrons of low energy through excitation of atomic nuclei in the plate-shaped target; and
performing nuclear transmutation of a first long-lived fission product through collisions of the first neutrons with the first long-lived fission product, the first neutrons forming a beam in an extension direction of an incident path of the primary particles to the plate-shaped target, and the first long-lived fission product being located in a direction of travel of the beam, and
performing nuclear transmutation of a second long-lived fission product located in proximity to the plate-shaped target through the second neutrons spreading out around the plate-shaped target.

2. The long-lived fission product processing method according to claim 1, wherein
the primary particles are deuterium nuclei or tritium nuclei.

3. The long-lived fission product processing method according to claim 1, wherein
the primary particles have an energy per nucleon of 50 MeV/nucleon or more when colliding with the plate-shaped target, and the plate-shaped target has a thickness of 1 mm or more.

4. The long-lived fission product processing method according to claim 1, wherein
a second target, instead of the first long-lived fission product, is located in the direction of travel of the beam of the first neutrons,
the beam of the first neutrons collides with the second target to generate negative pi-mesons,
the first long-lived fission product is located in proximity to the second target, and
nuclear transmutation of the first long-lived fission product is performed through negative muons resulting from decay of the negative pi-mesons.

5. The long-lived fission product processing method according to claim 1, wherein
a second target positioned in a first space, instead of the first long-lived fission product, is located in the direction of travel of the beam of the first neutrons,
the beam of the first neutrons collides with the second target to generate negative pi-mesons,
a second space filled with a gas of deuterium-tritium molecules is formed adjacently to the first space in which the second target is positioned, and a confining magnetic field is formed around the second space,
the negative pi-mesons move from the first space to the second space through an effect of the confining magnetic field,
negative muons resulting from decay of the negative pi-mesons cause a nuclear fusion reaction in the second space to generate third neutrons,
the first long-lived fission product is located in proximity to the second target, and
nuclear transmutation of the first long-lived fission product is performed through the third neutrons.
